(19) United States
(12) Patent Application Publication
(10) Pub. No.: US 2009/0135891 A1
(43) Pub. Date: May 28, 2009

(54) SYMBOL MODULATION ACCURACY MEASURING DEVICE, METHOD, PROGRAM, AND RECORDING MEDIUM

(75) Inventor: Takashi Shimura, Tochigi (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, Tokyo (JP)

(21) Appl. No.: 11/996,520

(22) PCT Filed: Jul. 21, 2006
(86) PCT No.: PCT/JP2006/314941

§ 371 Date: Jan. 23, 2008

(30) Foreign Application Priority Data
Jul. 26, 2005 (JP) 2005-216071

(51) Int. Cl. H04B 17/00

(52) U.S. Cl. 375/224

(57) ABSTRACT

An accuracy of a symbol modulation is accurately measured. A symbol modulation accuracy measuring device receives a signal to be measured from a signal output device, which outputs ideal symbol data generated by the ideal symbol data generating unit, and modulated by the symbol modulation unit according to a symbol modulation as the signal to be measured, via a memory, and measures the accuracy of the symbol modulation. The symbol modulation accuracy measuring device includes a symbol demodulation unit that demodulates the signal to be measured according to a symbol demodulation, and a modulation accuracy measuring unit that measures the accuracy of the symbol modulation based on a result of the demodulation by the symbol demodulation unit, and the ideal symbol data recorded in the ideal symbol data generating unit of the signal output device. The symbol modulation accuracy measuring unit acquires the ideal symbol data from the ideal symbol data generating unit via a digital interface or a recording medium.

### TECHNICAL FIELD

The present invention relates to a measurement of symbol modulation accuracy.

### BACKGROUND ART

Conventionally, a signal to be measured, which has been modulated according to a symbol modulation, is received, the received signal is converted into a digital signal, and an accuracy of the symbol modulation is measured (refer to a patent document 1 (Japanese Laid-Open Patent Publication No. H7(1995)-297859), for example). The signal to be measured is converted into a signal at an intermediate frequency, and is then converted into the digital signal. The digital signal is further detected according to a quadrature detection, is synchronized, and is demodulated according to a symbol demodulation. Ideal data (ideal symbol position) of a symbol is estimated based on a result of the symbol demodulation (a symbol position acquired by the symbol demodulation). The modulation accuracy is calculated based on the result of the symbol demodulation and the ideal data. There are multiple candidates for the ideal symbol position, and it is estimated that a candidate closest to the symbol position acquired by the symbol demodulation is the ideal symbol position.

However, according to the above prior art, an estimation of an ideal symbol position possibly fails if the accuracy of the modulation of the signal to be measured is extremely low. This is because the candidate of an ideal symbol position closest to the symbol position acquired by the symbol demodulation may not be a true ideal symbol position. If the estimation of the ideal symbol position fails, the correct modulation accuracy cannot be calculated.

Moreover, if the modulation accuracy is measured after conditions of the symbol modulation are changed, the symbol position acquired by the symbol demodulation changes, and the ideal symbol position estimated based thereon may also change. In this case, the estimated ideal symbol position is deviated from the true ideal symbol position, and the ideal symbol position cannot thus be estimated correctly. A value of the correct modulation accuracy cannot be calculated based on this ideal symbol position.

In view of the foregoing problems, an object of the present invention is to correctly measure an accuracy of a symbol modulation.

### DISCLOSURE OF THE INVENTION

According to one aspect of the present invention, a symbol modulation accuracy measuring device that receives a signal to be measured from a signal output device which outputs ideal symbol data modulated according to a symbol modulation as the signal to be measured, and measures the accuracy of the symbol modulation, includes: a symbol demodulation unit that demodulates the signal to be measured according to a symbol demodulation; and a modulation accuracy measuring unit that measures an accuracy of the symbol modulation based on a result of the demodulation by the symbol demodulation unit, and the ideal symbol data recorded in the signal output device.

According to the present invention, a symbol modulation accuracy measuring device that receives a signal to be measured from a signal output device which outputs ideal symbol data modulated according to a symbol modulation as the signal to be measured, and measures the accuracy of the symbol modulation, is provided.

A symbol demodulation unit demodulates the signal to be measured according to a symbol demodulation. A modulation accuracy measuring unit measures an accuracy of the symbol modulation based on a result of the demodulation by the symbol demodulation unit, and the ideal symbol data recorded in the signal output device.

According to the symbol modulation accuracy measuring device of the present invention, the symbol modulation accuracy measuring device may be connected to the signal output device via a digital interface; and the modulation accuracy measuring unit may acquire the ideal symbol data recorded in the signal output device via the digital interface.

According to the symbol modulation accuracy measuring device of the present invention, the ideal symbol data recorded in the signal output device may be recorded on a recording medium, and the modulation accuracy measuring unit may acquire the ideal symbol data from the recording medium.

According to another aspect of the present invention, a symbol modulation accuracy measuring device that receives a signal to be measured from a signal output device which generates ideal symbol data according to a predetermined method, and outputs the ideal symbol data modulated according to a symbol modulation as the signal to be measured, and measures the accuracy of the symbol modulation, includes: a symbol demodulation unit that demodulates the signal to be measured according to a symbol demodulation; a corresponding ideal symbol data generating unit that generates the ideal symbol data according to the predetermined method; and a modulation accuracy measuring unit that measures an accuracy of the symbol modulation based on a result of the demodulation by the symbol demodulation unit, and the ideal symbol data generated by the corresponding ideal symbol data generating unit.

According to the present invention, a symbol modulation accuracy measuring device that receives a signal to be measured from a signal output device which generates ideal symbol data according to a predetermined method, and outputs the ideal symbol data modulated according to a symbol modulation as the signal to be measured, and measures the accuracy of the symbol modulation, is provided.

A symbol demodulation unit demodulates the signal to be measured according to a symbol demodulation. A corresponding ideal symbol data generating unit generates the ideal symbol data according to the predetermined method. A modulation accuracy measuring unit measures an accuracy of the symbol modulation based on a result of the demodulation by the symbol demodulation unit, and the ideal symbol data generated by the corresponding ideal symbol data generating unit.

According to another aspect of the present invention, a symbol modulation accuracy measuring method that receives a signal to be measured from a signal output device which outputs ideal symbol data modulated according to a symbol modulation as the signal to be measured, and measures the accuracy of the symbol modulation, includes: a symbol demodulation step that demodulates the signal to be measured according to a symbol demodulation; and a modulation accuracy measuring step that measures an accuracy of the symbol modulation based on a result of the demodulation by the symbol demodulation step, and the ideal symbol data recorded in the signal output device.

According to another aspect of the present invention, a symbol modulation accuracy measuring method that receives a signal to be measured from a signal output device which generates ideal symbol data according to a predetermined method, and outputs the ideal symbol data modulated according to a symbol modulation as the signal to be measured, and measures the accuracy of the symbol modulation, includes: a symbol demodulation step that demodulates the signal to be measured according to a symbol demodulation; a corresponding ideal symbol data generating step that generates the ideal symbol data according to the predetermined method; and a modulation accuracy measuring step that measures an accuracy of the symbol modulation based on a result of the demodulation by the symbol demodulation step, and the ideal symbol data generated by the corresponding ideal symbol data generating step.

Another aspect of the present invention is a program of instructions for execution by the computer to perform a symbol modulation accuracy measuring process that receives a signal to be measured from a signal output device which outputs ideal symbol data modulated according to a symbol modulation as the signal to be measured, and measures the accuracy of the symbol modulation, the symbol modulation accuracy measuring process including: a symbol demodulation step that demodulates the signal to be measured according to a symbol demodulation; and a modulation accuracy measuring step that measures an accuracy of the symbol modulation based on a result of the demodulation by the symbol demodulation step, and the ideal symbol data recorded in the signal output device.

Another aspect of the present invention is a program of instructions for execution by the computer to perform a symbol modulation accuracy measuring process that receives a signal to be measured from a signal output device which generates ideal symbol data according to a predetermined method, and outputs the ideal symbol data modulated according to a symbol modulation as the signal to be measured, and measures the accuracy of the symbol modulation, the symbol modulation accuracy measuring process including: a symbol demodulation step that demodulates the signal to be measured according to a symbol demodulation; a corresponding ideal symbol data generating step that generates the ideal symbol data according to the predetermined method; and a modulation accuracy measuring step that measures an accuracy of the symbol modulation based on a result of the demodulation by the symbol demodulation step, and the ideal symbol data generated by the corresponding ideal symbol data generating step.

Another aspect of the present invention is a computer-readable medium having a program of instructions for execution by the computer to perform a symbol modulation accuracy measuring process that receives a signal to be measured from a signal output device which outputs ideal symbol data modulated according to a symbol modulation as the signal to be measured, and measures the accuracy of the symbol modulation, the symbol modulation accuracy measuring process including: a symbol demodulation step that demodulates the signal to be measured according to a symbol demodulation; and a modulation accuracy measuring step that measures an accuracy of the symbol modulation based on a result of the demodulation by the symbol demodulation step, and the ideal symbol data recorded in the signal output device.

Another aspect of the present invention is a computer-readable medium having a program of instructions for execution by the computer to perform a symbol modulation accuracy measuring process that receives a signal to be measured from a signal output device which generates ideal symbol data according to a predetermined method, and outputs the ideal symbol data modulated according to a symbol modulation as the signal to be measured, and measures the accuracy of the symbol modulation, the symbol modulation accuracy measuring process including: a symbol demodulation step that demodulates the signal to be measured according to a symbol demodulation; a corresponding ideal symbol data generating step that generates the ideal symbol data according to the predetermined method; and a modulation accuracy measuring step that measures an accuracy of the symbol modulation based on a result of the demodulation by the symbol demodulation step, and the ideal symbol data generated by the corresponding ideal symbol data generating step.

According to the symbol modulation accuracy measuring device of the present invention, the signal to be measured is received via a device under test.

According to the present invention, a measuring device includes: the symbol modulation accuracy measuring device; and the signal output device, wherein the measuring device measures the device under test.

### BRIEF DESCRIPTION OF THE DRAWINGS

FIG. 1 is a functional block diagram showing a configuration of a measuring system employing a symbol modulation accuracy measuring device 30 according to a first embodiment of the present invention;

FIG. 2 shows ideal symbol data 12a, 12b, 12c, and 12d, and demodulated data 36a;

FIG. 3 describes an aspect where the ideal symbol data 12a to 12d are acquired via a digital interface 40;

FIG. 4 describes an aspect where the ideal symbol data 12a to 12d are acquired via a recording medium 50;

FIG. 5 is a functional block diagram showing a configuration of a measuring system employing the symbol modulation accuracy measuring device 30 according to a second embodiment of the present invention; and

FIG. 6 is a functional block diagram showing a configuration of a measuring system employing the symbol modulation accuracy measuring device 30 according to a third embodiment of the present invention.

### BEST MODE FOR CARRYING OUT THE INVENTION

A description will now be given of embodiments of the present invention with reference to drawings.

### First Embodiment

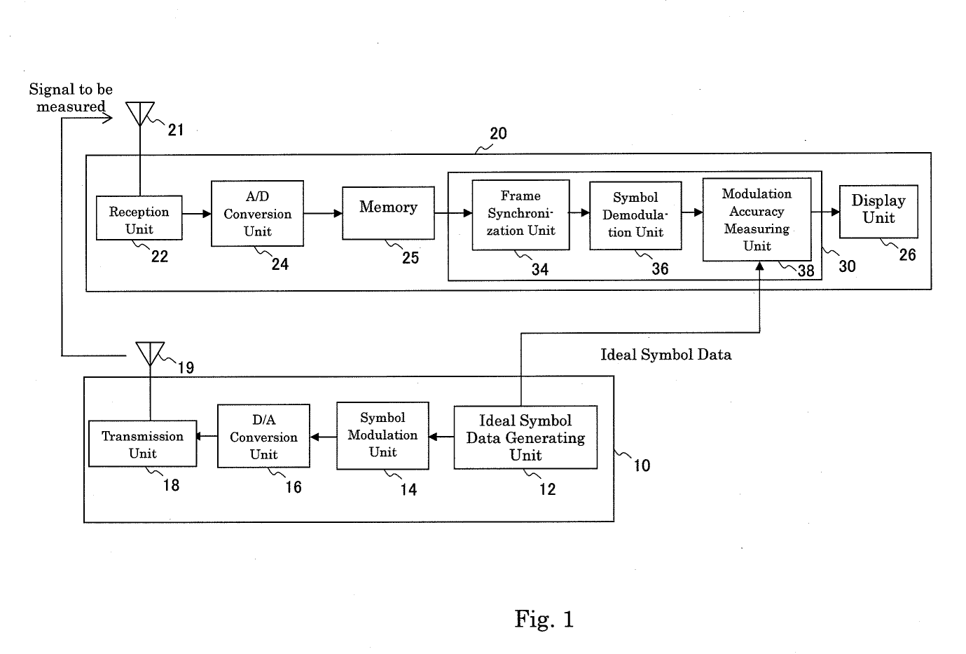

FIG. 1 is a functional block diagram showing a configuration of a measuring system employing a symbol modulation accuracy measuring device 30 according to a first embodiment of the present invention. The measuring system according to the first embodiment includes a signal output device 10 and a modulated signal analyzing and display device 20.

The signal output device 10 outputs ideal symbol data modulated according to a symbol modulation as a signal to be measured. The signal output device 10 includes an ideal symbol data generating unit 12, a symbol modulation unit 14, a D/A conversion unit 16, a transmission unit 18, and an antenna 19.

The ideal symbol data generating unit 12 generates the ideal symbol data. It should be noted that the ideal symbol data generating unit 12 records the generated ideal symbol data.

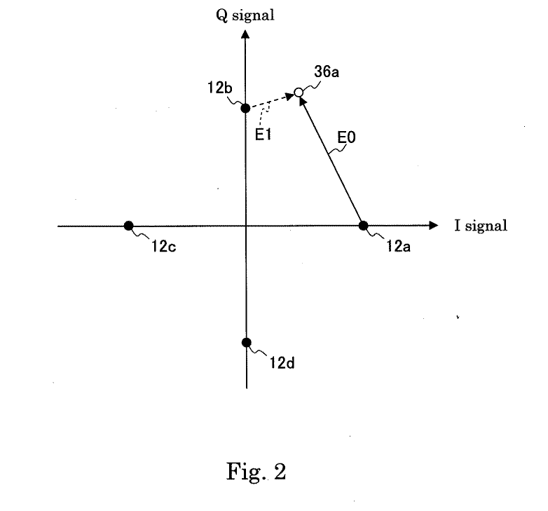

FIG. 2 shows ideal symbol data 12a, 12b, 12c, and 12d, and demodulated data 36a. In FIG. 2, an I signal denotes the real part and a Q signal denotes the imaginary part. A method representing ideal symbol data and demodulated data as shown in FIG. 2 is referred to as constellation. The positions of the ideal symbol data 12a, 12b, 12c, and 12d are defined according to a standard. In the example shown in FIG. 2, the ideal symbol data 12a is at a coordinate (1,0); the ideal symbol data 12b is at a coordinate (0,1); the ideal symbol data 12c is at a coordinate (−1,0); and the ideal symbol data 12d is at a coordinate (0,−1).

The symbol modulation unit 14 receives the ideal symbol data from the ideal symbol data generating unit 12, and carries out the symbol modulation. A result of the symbol modulation is a digital signal.

The D/A conversion unit 16 receives the result of the symbol modulation (digital signal) from the symbol modulation unit 14, and converts the signal into an analog signal.

The transmission unit 18 receives the result of the symbol modulation (analog signal) from the D/A conversion unit 16, and transmits the signal to the modulated signal analyzing and display device 20 via the antenna 19. The result of the symbol modulation (analog signal) transmitted to the modulated signal analyzing and display device 20 is referred to as signal to be measured. In this way, the ideal symbol data modulated according to the symbol modulation is output as the signal to be measured.

The modulated signal analyzing and display device 20 includes an antenna 21, a reception unit 22, an A/D conversion unit 24, a memory 25, a display unit 26, and a symbol modulation accuracy measuring device 30.

The reception unit 22 receives the signal to be measured output (transmitted) by the signal output device 10 via the antenna 21.

The A/D conversion unit 24 converts the signal to be measured (analog signal) received by the reception unit 22 into a digital signal.

The memory 25 records the signal to be measured (digital signal) output by the A/D conversion unit 24.

The display unit 26 receives and displays a measurement result of a symbol modulation accuracy from the symbol modulation accuracy measuring device 30.

The symbol modulation accuracy measuring device 30 receives the signal to be measured from the signal output device 10 via the memory 25, and measures the accuracy of the symbol modulation.

The symbol modulation accuracy measuring device 30 includes a frame synchronization unit 34, a symbol demodulation unit 36, and the modulation accuracy measuring unit 38.

The frame synchronization unit 34 finds out a frame start position of the signal to be measured (digital signal) from the record in the memory 25.

The symbol demodulation unit 36 demodulates the signal to be measured (digital) starting from the frame start position according to the symbol demodulation.

The modulation accuracy measuring unit 38 measures the accuracy of the symbol modulation based on the result of the demodulation by the symbol demodulation unit 36 and the ideal symbol data recorded in the ideal symbol data generating unit 12 of the signal output device 10.

With reference to FIG. 2, it is assumed that the ideal symbol data 12a is modulated by the symbol modulation unit 14, and is demodulated by the symbol demodulation unit 36 resulting in the demodulated data 36a. An error between the ideal symbol data 12a and the demodulated data 36a is then E0. The accuracy of the symbol modulation is measured based on this error E0. According to prior art, it is estimated that the ideal symbol data 12b closest to the demodulated data 36a is modulated and demodulated to the demodulated data 36a. Therefore, an incorrect result that the error is E1 is reached, and an incorrect value is acquired for the accuracy of the symbol modulation.

The modulation accuracy measuring unit 38 acquires the ideal symbol data 12a to 12d recorded in the ideal symbol data generating unit 12 of the signal output device 10 via the digital interface 40 or the recording medium 50. As a result, it is accurately determined that the demodulated data 36a is obtained as a result of modulating and then demodulating the ideal symbol data 12a.

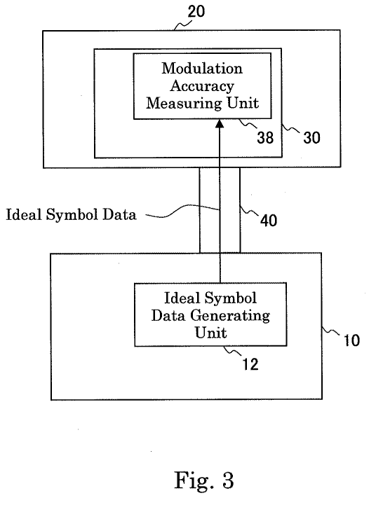

FIG. 3 describes an aspect where the ideal symbol data 12a to 12d are acquired via the digital interface 40. It should be noted that FIG. 3 illustrates only the ideal symbol data generating unit 12 of the signal output device 10, the symbol modulation accuracy measuring device 30 of the modulated signal analyzing and display device 20, and the modulation accuracy measuring unit 38 of the symbol modulation accuracy measuring device 30, and the other parts are omitted.

The symbol modulation accuracy measuring device 30 is connected to the signal output device 10 via the modulated signal analyzing and display device 20 by the digital interface 40. The digital interface 40 may be serial or parallel.

The modulation accuracy measuring unit 38 reads out the ideal symbol data 12a to 12d recorded in the ideal symbol data generating unit 12 of the signal output device 10 from the ideal symbol data generating unit 12 of the signal output device 10 via the digital interface 40.

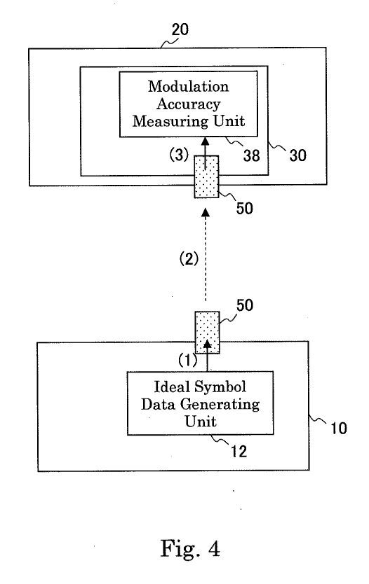

FIG. 4 describes an aspect where the ideal symbol data 12a to 12d are acquired via the recording medium 50. It should be noted that FIG. 4 also illustrates only the ideal symbol data generating unit 12 of the signal output device 10, the symbol modulation accuracy measuring device 30 of the modulated signal analyzing and display device 20, and the modulation accuracy measuring unit 38 of the symbol modulation accuracy measuring device 30, and the other parts are omitted.

The recording medium 50 is a floppy (registered trade mark) disk, a hard disk, or a USB memory, for example.

First, the recording medium 50 is mounted on a recording medium writing device (such as a USB port) of the signal output device 10. Then, (1) the ideal symbol data 12a to 12d recorded in the ideal symbol data generating unit 12 of the signal output device 10 are written to the recording medium 50. Then, (2) the recording medium 50 is dismounted from the signal output device 10, and is then mounted on a recording medium reading device (such as a USB port) of the modulation signal analyzing and display device 20. Then, (3) the modulation accuracy measuring unit 38 reads the ideal symbol data 12a to 12d from the recording medium 50.

A description will now be given of an operation of the first embodiment.

First, the ideal symbol data generating unit 12 generates ideal symbol data 12a to 12d. The ideal symbol data 12a to 12d are supplied to the modulation accuracy measuring unit 38 via the digital interface 40 (refer to FIG. 3) or the recording medium 50 (refer to FIG. 4).

The ideal symbol data 12a to 12d are modulated according to the symbol modulation by the symbol modulation unit 14. The result of the symbol modulation (digital signal) is converted into the analog signal by the D/A conversion unit 16. The result of the symbol modulation (analog signal) is transmitted as a signal to be measured from the transmission unit 18 to the modulation signal analyzing and display device 20 via the antenna 19.

The signal to be measured is received by the reception unit 22 via the antenna 21. The A/D conversion unit 24 converts the signal to be measured (analog signal) received by the reception unit 22 into a digital signal. The memory 25 records the signal to be measured (digital signal) output by the A/D conversion unit 24.

The frame synchronization unit 34 finds out the frame start position of the signal to be measured (digital signal) from the record in the memory 25. The symbol demodulation unit 36 demodulates the signal to be measured (digital) starting from the frame start position according to the symbol demodulation. The result of the demodulation by the symbol demodulation unit 36 is supplied to the modulation accuracy measuring unit 38.

The modulation accuracy measuring unit 38 measures the accuracy of the symbol modulation based on the result of the demodulation by the symbol demodulation unit 36 and the ideal symbol data recorded in the ideal symbol data generating unit 12 of the signal output device 10.

With reference to FIG. 2, the error E0 between the ideal symbol data 12a and the demodulated data 36a is acquired based on the demodulation result (demodulated data 36a) by the symbol demodulation unit 36 and the ideal symbol data 12a recorded in the ideal symbol data generating unit 12 of the signal output device 10. The accuracy of the symbol modulation is measured based on this error E0.

On this occasion, according to prior art, it is estimated that the ideal symbol data 12b closest to the demodulated data 36a is modulated and demodulated to the demodulated data 36a. Therefore, the incorrect result that the error is E1 is reached, and the incorrect value is acquired for the accuracy of the symbol modulation.

However, according to the first embodiment, the ideal symbol data 12a is supplied from the signal output device 10 which has output the signal to be measured to the modulation accuracy measuring unit 38. As a result, it is determined that the demodulated data 36a is obtained as a result of modulating and then demodulating the ideal symbol data 12a.

The measured accuracy of the symbol modulation is shown by the display unit 26.

According to the first embodiment, since it is possible to accurately determine which of the ideal symbol data 12a to 12d is modulated and then demodulated into the acquired demodulated data 36a, it is possible to accurately determine the symbol modulation accuracy.

### Second Embodiment

A second embodiment is different from the first embodiment in that a corresponding ideal symbol data generating unit 32 is employed in place of using the digital interface 40 and the recording medium 50.

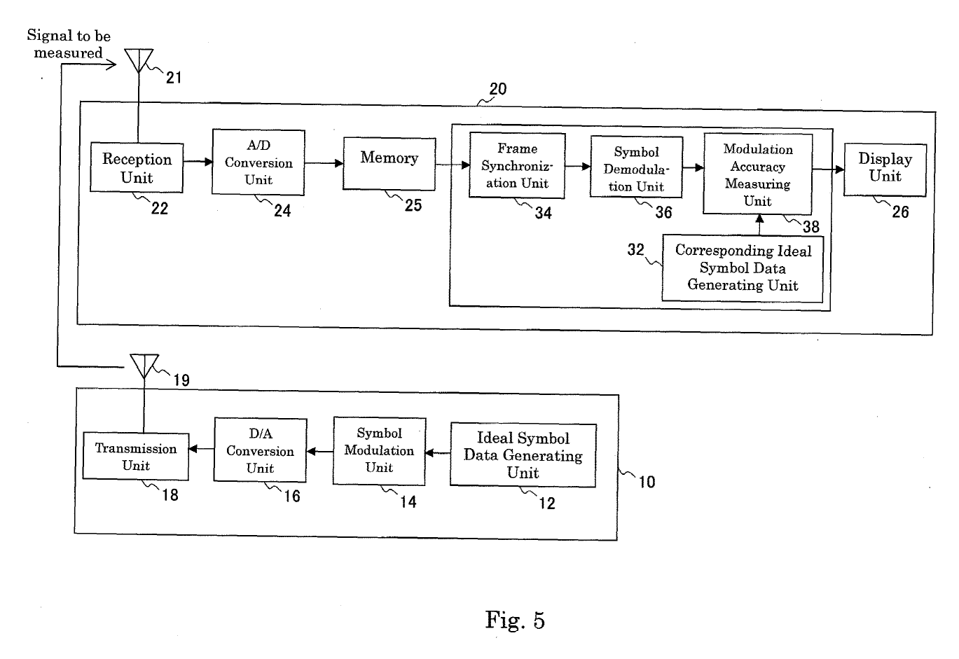

FIG. 5 is a functional block diagram showing a configuration of a measuring system employing the symbol modulation accuracy measuring device 30 according to the second embodiment of the present invention. The measuring system according to the second embodiment includes the signal output device 10 and the modulated signal analyzing and display device 20. In the following section, like components are denoted by like numerals as of the first embodiment, and will be explained in no more details.

The signal output device 10 outputs the ideal symbol data modulated according to the symbol modulation as the signal to be measured. The signal output device 10 includes the ideal symbol data generating unit 12, the symbol modulation unit 14, the D/A conversion unit 16, the transmission unit 18, and the antenna 19. The signal output device 10 is similar to that of the first embodiment, and hence a description is omitted.

It should be noted that the ideal symbol data generating unit 12 has generated the ideal symbol data according to a predetermined method.

The modulated signal analyzing and display device 20 includes the antenna 21, the reception unit 22, the A/D conversion unit 24, the memory 25, the display unit 26, and the symbol modulation accuracy measuring device 30. The antenna 21, the reception unit 22, the A/D conversion unit 24, the memory 25, and the display unit 26 are similar to those of the first embodiment, and hence a description is omitted.

The symbol modulation accuracy measuring device 30 receives the signal to be measured from the signal output device 10 via the memory 25, and measures the accuracy of the symbol modulation. The symbol modulation accuracy measuring device 30 includes the corresponding ideal symbol data generating unit 32, the frame synchronization unit 34, the symbol demodulation unit 36, and the modulation accuracy measuring unit 38. The frame synchronization unit 34 and the symbol demodulation unit 36 are similar to those in the first embodiment, and a description thereof, therefore, is omitted.

The corresponding ideal symbol data generating unit 32 generates the ideal symbol data by a predetermined method as of the ideal symbol data generating unit 12 (namely, according to the same method as of the ideal symbol data generating unit 12).

The modulation accuracy measuring unit 38 measures the accuracy of the symbol modulation based on the result of the demodulation by the symbol demodulation unit 36 and the ideal symbol data generated by the corresponding ideal symbol data generating unit 32. Since the corresponding ideal symbol data generating unit 32 generates the ideal symbol data according to the same method (predetermined method) as of the ideal symbol data generating unit 12, it is possible to generate the accurate ideal symbol data.

A description will now be given of an operation of the second embodiment.

An operation of the signal output device 10 is similar to that of the first embodiment, and hence a description is omitted. It should be noted that the ideal symbol data 12a to 12d recorded by the ideal symbol data generating unit 12 is not especially supplied to the modulation accuracy measuring unit 38.

The signal to be measured is received by the reception unit 22 via the antenna 21. The A/D conversion unit 24 converts the signal to be measured (analog signal) received by the reception unit 22 into a digital signal. The memory 25 records the signal to be measured (digital signal) output by the A/D conversion unit 24.

The frame synchronization unit 34 finds out a frame start position of the signal to be measured (digital signal) from the record in the memory 25. The symbol demodulation unit 36 demodulates the signal to be measured (digital) starting from the frame start position according to the symbol demodulation. The result of the demodulation by the symbol demodulation unit 36 is supplied to the modulation accuracy measuring unit 38.

The corresponding ideal symbol data generating unit 32 generates the ideal symbol data by a predetermined method as of the ideal symbol data generating unit 12 (namely, according to the same method as of the ideal symbol data generating unit 12).

The modulation accuracy measuring unit 38 measures the accuracy of the symbol modulation based on the result of the demodulation by the symbol demodulation unit 36 and the ideal symbol data generated by the corresponding ideal symbol data generating unit 32. Since the corresponding ideal symbol data generating unit 32 generates the ideal symbol data according to the same method (predetermined method) as of the ideal symbol data generating unit 12, it is possible to generate the accurate ideal symbol data.

According to the second embodiment, there are obtained effects similar to those of the first embodiment.

### Third Embodiment

A third embodiment is different from the first embodiment in that the signal output device 10 and the modulated signal analyzing and display device 20 are unified, and the reception unit 22 receives the signal to be measured from the transmission unit 18 via a device under test (DUT) 2.

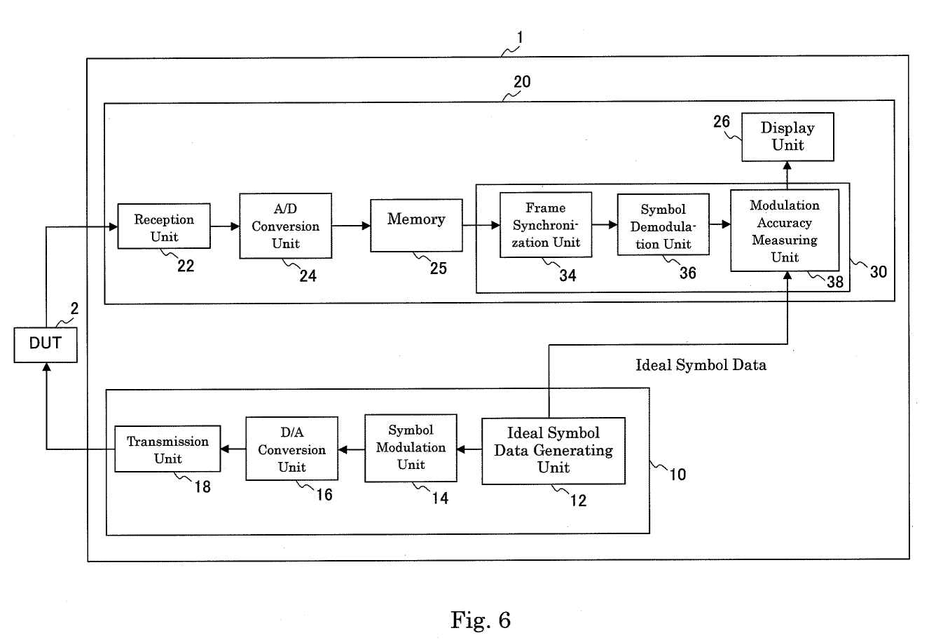

FIG. 6 is a functional block diagram showing a configuration of a measuring system employing the symbol modulation accuracy measuring device 30 according to the third embodiment of the present invention. The measuring system according to the third embodiment includes a semiconductor test device (measuring device) 1, and the device under test (DUT) 2. In the following section, like components are denoted by like numerals as of the first embodiment, and will be explained in no more details.

The semiconductor test device (measuring device) 1 includes the signal output device 10 and the modulation signal analyzing and display device 20. The signal output device 10 and the modulation signal analyzing and display device 20 are unified in the semiconductor test device 1. The signal output device 10 and the modulation signal analyzing and display device 20 are similar to those of the first embodiment, and hence a description is omitted.

It should be noted that the ideal symbol data generating unit 12 and the modulation accuracy measuring unit 38 are connected with each other by wiring inside the semiconductor test device 1. The modulation accuracy measuring unit 38 acquires the ideal symbol data 12a to 12d recorded in the ideal symbol data generating unit 12 via this wiring.

Moreover, the transmission unit 18 supplies the DUT 2 with the result of the symbol modulation (analog signal). Further, the reception unit 22 receives the signal to be measured output (transmitted) by the signal output device 10 via the DUT 2.

It should be noted that the DUT 2 is to be measured by the semiconductor test device 1. The DUT 2 is an amplifier or transceiver IC (Integrated Circuit), for example.

An operation of the third embodiment is similar to that of the first embodiment, and hence a description is omitted.

With the semiconductor test device 1 according to the third embodiment, it is possible to accurately measure the DUT 2. This is because it is correctly determined which of the ideal symbol data 12a to 12d is modulated and then demodulated into the demodulated data 36a.

It should be noted that, according to the above embodiments, the ideal symbol data 12a to 12d is supplied to the modulation accuracy measuring unit 38 (first and third embodiments), or is generated by the corresponding ideal symbol data generating unit 32 (second embodiment).

However, if the signal to be measured is compliant to a standard such as the OFDM ((Orthogonal Frequency Division Multiplexing) or the CDMA (Code Division Multiple Access), it is considered that supplying or generating only the ideal symbol data 12a to 12d is not sufficient. The following data is thus preferably supplied or generated.

(1) If the signal to be measured is a signal compliant to the OFDM,

vectors for respective subcarriers (coordinate data on the IQ plane),

a code indicating the standard (indicating how the signal is to be processed),

an FFT sampling frequency,

an FFT point number,

a GI point number,

vector numbers for the respective subcarriers,

modulation methods for the respective subcarriers, and

types of the subcarriers (such as pilot) are preferably supplied or generated. These are considered as data on the frequency axis.

(2) If the signal to be measured is a signal compliant to the CDMA,

the number of code channels,

types of the respective code channels (such as pilot or data),

spread codes of the respective code channels,

vectors of respective symbols of the respective code channels,

(magnitudes of) powers of the respective code channels,

spread factors of the respective code channels (axis of chart), and

modulation methods of the respective code channels are preferably supplied or generated. These are considered as multiplexed data on the code axis.

It should be noted that the above-described embodiment may be realized in the following manner. A computer is provided with a CPU, a hard disk, and a media (such as a floppy disk (registered trade mark) and a CD-ROM) reader, and the media reader is caused to read a medium recording a program realizing the above-described respective components (such as the corresponding ideal symbol data generating unit 32, the frame synchronization unit 34, the symbol demodulation unit 36, and the modulation accuracy measuring unit 38), thereby installing the program on the hard disk. This method may also realize the above-described embodiment.

1. A symbol modulation accuracy measuring device that receives a signal to be measured from a signal output device which outputs ideal symbol data modulated according to a symbol modulation as the signal to be measured, and measures the accuracy of the symbol modulation, comprising:
a symbol demodulator that demodulates the signal to be measured according to a symbol demodulation; and
a modulation accuracy measurer that measures an accuracy of the symbol modulation based on a result of the demodulation by said symbol demodulator, and the ideal symbol data recorded in the signal output device.

2. A symbol modulation accuracy measuring device according to claim 1, wherein:
the symbol modulation accuracy measuring device is connected to the signal output device via a digital interface; and
said modulation accuracy measurer acquires the ideal symbol data recorded in the signal output device via the digital interface.

3. A symbol modulation accuracy measuring device according to claim 1, wherein:
the ideal symbol data recorded in the signal output device is recorded on a recording medium, and
said modulation accuracy measurer acquires the ideal symbol data from the recording medium.

4. A symbol modulation accuracy measuring device that receives a signal to be measured from a signal output device which generates ideal symbol data according to a predetermined method, and outputs the ideal symbol data modulated according to a symbol modulation as the signal to be measured, and measures the accuracy of the symbol modulation, comprising:
a symbol demodulator that demodulates the signal to be measured according to a symbol demodulation;
a corresponding ideal symbol data generator that generates the ideal symbol data according to the predetermined method; and
a modulation accuracy measurer that measures an accuracy of the symbol modulation based on a result of the demodulation by said symbol demodulator, and the ideal symbol data generated by said corresponding ideal symbol data generator.

5. A symbol modulation accuracy measuring method that receives a signal to be measured from a signal output device which outputs ideal symbol data modulated according to a symbol modulation as the signal to be measured, and measures the accuracy of the symbol modulation, comprising:
demodulating the signal to be measured according to a symbol demodulation; and
measuring an accuracy of the symbol modulation based on a result of the demodulating and the ideal symbol data recorded in the signal output device.

6. A symbol modulation accuracy measuring method that receives a signal to be measured from a signal output device which generates ideal symbol data according to a predetermined method, and outputs the ideal symbol data modulated according to a symbol modulation as the signal to be measured, and measures the accuracy of the symbol modulation, comprising:
demodulating the signal to be measured according to a symbol demodulation;
generating the ideal symbol data according to the predetermined method; and
measuring an accuracy of the symbol modulation based on a result of the demodulating and the ideal symbol data generated.

7. A program of instructions for execution by the computer to perform a symbol modulation accuracy measuring process that receives a signal to be measured from a signal output device which outputs ideal symbol data modulated according to a symbol modulation as the signal to be measured, and measures the accuracy of the symbol modulation, the symbol modulation accuracy measuring process comprising:
demodulating the signal to be measured according to a symbol demodulation; and
measuring an accuracy of the symbol modulation based on a result of the demodulating and the ideal symbol data recorded in the signal output device.

8. A program of instructions for execution by the computer to perform a symbol modulation accuracy measuring process that receives a signal to be measured from a signal output device which generates ideal symbol data according to a predetermined method, and outputs the ideal symbol data modulated according to a symbol modulation as the signal to be measured, and measures the accuracy of the symbol modulation, the symbol modulation accuracy measuring process comprising:
demodulating the signal to be measured according to a symbol demodulation;
generating the ideal symbol data according to the predetermined method; and
measuring an accuracy of the symbol modulation based on a result of the demodulating and the ideal symbol data generated.

9. A computer-readable medium having a program of instructions for execution by the computer to perform a symbol modulation accuracy measuring process that receives a signal to be measured from a signal output device which outputs ideal symbol data modulated according to a symbol modulation as the signal to be measured, and measures the accuracy of the symbol modulation, the symbol modulation accuracy measuring process comprising:
demodulating the signal to be measured according to a symbol demodulation; and
measuring an accuracy of the symbol modulation based on a result of the demodulating and the ideal symbol data recorded in the signal output device.

10. A computer-readable medium having a program of instructions for execution by the computer to perform a symbol modulation accuracy measuring process that receives a signal to be measured from a signal output device which generates ideal symbol data according to a predetermined method, and outputs the ideal symbol data modulated according to a symbol modulation as the signal to be measured, and measures the accuracy of the symbol modulation, the symbol modulation accuracy measuring process comprising:
demodulating the signal to be measured according to a symbol demodulation;
generating the ideal symbol data according to the predetermined method; and
measuring an accuracy of the symbol modulation based on a result of the demodulating and the ideal symbol data generated.

11. A symbol modulation accuracy measuring device according to claim 1, wherein the signal to be measured is received via a device under test.

12. A measuring device comprising:
the symbol modulation accuracy measuring device according to claim 11; and
the signal output device,
wherein the measuring device measures the device under test.
